(19) United States
(12) Patent Application Publication
(10) Pub. No.: US 2019/0369997 A1
(43) Pub. Date: Dec. 5, 2019

(54) SIMULATION DEVICE, SIMULATION METHOD, AND COMPUTER READABLE MEDIUM

(71) Applicant: MITSUBISHI ELECTRIC CORPORATION, Tokyo (JP)

(72) Inventors: Shohei KOYAMA, Tokyo (JP); Daisuke OGAWA, Tokyo (JP); Masakatsu TOYAMA, Tokyo (JP)

(73) Assignee: MITSUBISHI ELECTRIC CORPORATION, Tokyo (JP)

(21) Appl. No.: 16/475,308

(22) PCT Filed: Feb. 28, 2017
(86) PCT No.: PCT/JP2017/007943

§ 371 Date: Jul. 1, 2019

(51) Int. Cl. G06F 9/32; G06F 12/0802

(52) U.S. Cl. CPC G06F 9/321; G06F 12/0802

(57) ABSTRACT

A simulation device executes simulation of a program including a first function and a second function that are similar to each other. An address information storage unit stores address information in which a first start address and a first end address of the first function are associated with a second start address and a second end address of the second function. When an original address is in between the first start address and the first end address, an address rearrangement unit rearranges the original address to between the second start address and the second end address as a processing address. An evaluation unit executes cache simulation on the processing address, to evaluate whether to be a cache hit or a cache miss.

### TECHNICAL FIELD

The present invention relates to a simulation device, a simulation method, and a simulation program. In particular, the present invention relates to a simulation device, a simulation method, and a simulation program for simulating program execution in development of an embedded device.

### BACKGROUND ART

Recent embedded devices employ high-performance processors, and thus are greatly affected by functions such as caching or conditional branching. Implementing software that efficiently utilizes such functions satisfies hardware performance as expected by a user. Whereas, if software that cannot fully utilize such functions is implemented, hardware performance as expected by a user cannot be satisfied. Therefore, it is necessary to detect processing of software causing performance degradation and to improve to software that can efficiently utilize the functions of hardware.

Patent Literature 1 discloses a technique for measuring performance when data on a memory is rearranged, by using a performance evaluation simulator.

### CITATION LIST

### Patent Literature

Patent Literature 1: JP 2014-142682 A

### SUMMARY OF INVENTION

### Technical Problem

In Patent Literature 1, it is not possible to efficiently perform performance evaluation when standardizing overlapping codes. Performing software refactoring to improve performance and standardizing overlapping codes require man-hours to change a data reference relationship or a function interface. The overlapping codes refer to instruction codes of functions that are performing similar processing. If there is no improvement in performance by refactoring, man-hours taken for the refactoring will be wasted.

The present invention provides a simulation device capable of evaluating performance in virtually standardizing overlapping codes.

### Solution to Problem

A simulation device for executing simulation of a program including a first function and a second function that are similar to each other, according to the present invention, includes:

an address information storage unit to store address information in which a first start address that is a start address of an instruction sequence of the first function, a first end address that is an end address of an instruction sequence of the first function, a second start address that is a start address of an instruction sequence of the second function, and a second end address that is an end address of an instruction sequence of the second function, are associated with each other;

an address rearrangement unit to acquire, as an original address, an address of an instruction sequence for executing simulation, to determine whether the original address is in between the first start address and the first end address using the address information, to rearrange the original address to between the second start address and the second end address when the original address is in between the first start address and the first end address, and to set a rearranged address as a processing address; and

an evaluation unit to execute cache simulation on the processing address, and to evaluate whether to be a cache hit or a cache miss.

### Advantageous Effects of Invention

The simulation device according to the present invention executes simulation of a program including a first function and a second function that are similar to each other. An address information storage unit stores address information in which: a first start address that is a start address of an instruction sequence of a first function; a first end address that is an end address of an instruction sequence of the first function; a second start address that is an start address of an instruction sequence of the second function; and a second end address that is an end address of an instruction sequence of the second function, are associated with each other. An address rearrangement unit rearranges an original address to between the second start address and the second end address as a processing address, when the original address is in between the first start address and the first end address. An evaluation unit executes cache simulation on the processing address, to evaluate whether to be a cache hit or a cache miss. Therefore, according to the simulation device of the present invention, it is possible to evaluate the performance when virtually standardizing overlapping codes before refactoring a program, and to suppress occurrence of unnecessary refactoring.

### BRIEF DESCRIPTION OF DRAWINGS

FIG. 1 is a configuration diagram of a simulation device 100 according to a first embodiment.

FIG. 2 is a configuration view of address information 421 according to the first embodiment.

FIG. 3 is a flowchart of a simulation process S100 of a simulation method 610 and a simulation program 620 according to the first embodiment.

FIG. 4 is a flowchart of an address rearrangement process S20 according to the first embodiment.

FIG. 5 is a configuration diagram of a simulation device 100 according to a modification of the first embodiment.

### DESCRIPTION OF EMBODIMENTS

### First Embodiment

### Description of Configuration

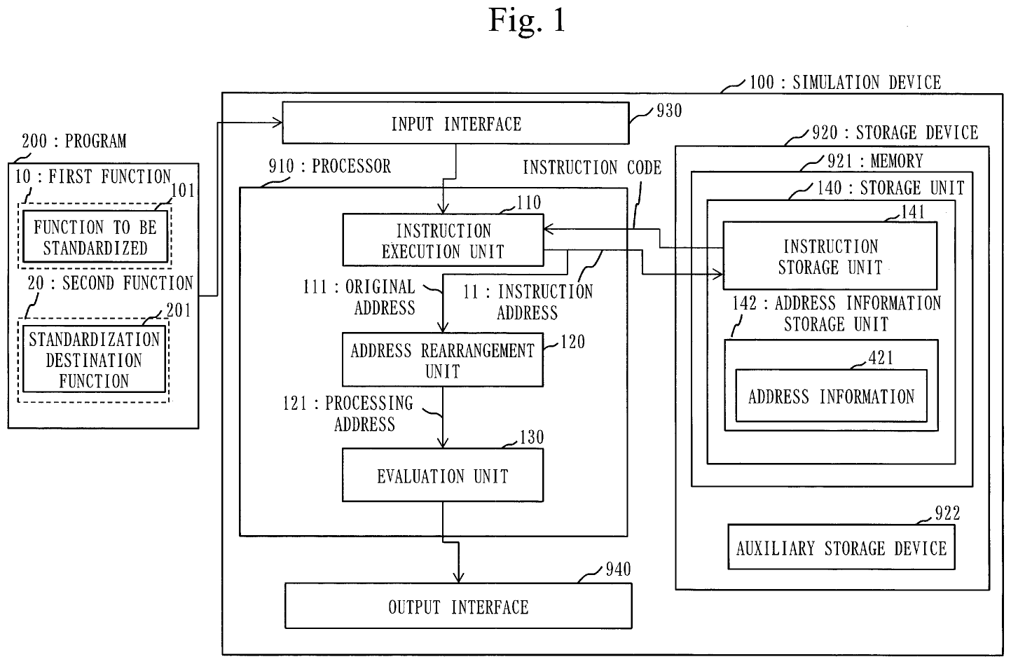

A configuration of a simulation device 100 according to the present embodiment will be described with reference to FIG. 1. The simulation device 100 according to the present embodiment executes simulation of a program 200 including a first function 10 and a second function 20 that are similar to each other. The first function 10 and the second function 20 similar to each other are also referred to as overlapping codes. The simulation device 100 can evaluate performance when the overlapping codes are virtually standardized.

The overlapping codes refer to a plurality of functions that are performing similar processing. In the present embodiment, the first function 10 is also referred to as a function to be standardized 101 that is a function of a standardization target. Further, the second function 20 is also referred to as a standardization destination function 201 that is a function of a standardization destination.

Evaluating performance in virtually standardizing means to perform cache simulation to determine whether to be a cache hit or a cache miss, while assuming that the function to be standardized 101 has been standardized to the standardization destination function 201 that is one function of a standardization destination.

As illustrated in FIG. 1, the simulation device 100 is a computer.

The simulation device 100 includes hardware such as a processor 910, a storage device 920, an input interface 930, and an output interface 940. The storage device 920 includes a memory 921 and an auxiliary storage device 922.

The simulation device 100 includes an instruction execution unit 110, an address rearrangement unit 120, an evaluation unit 130, and a storage unit 140 as functional components. The storage unit 140 includes an instruction storage unit 141 and an address information storage unit 142. The address information storage unit 142 stores address information 421.

Each function of the instruction execution unit 110, the address rearrangement unit 120, and the evaluation unit 130 is realized by software.

The storage unit 140 is realized by the memory 921. Further, the storage unit 140 may be realized by only the auxiliary storage device 922, or by the memory 921 and the auxiliary storage device 922. The storage unit 140 may be realized by any method.

The processor 910 is connected to other pieces hardware via a signal line, and controls these other pieces of hardware. The processor 910 is an integrated circuit (IC) that performs arithmetic processing. Specific examples of the processor 910 are a central processing unit (CPU), a digital signal processor (DSP), and a graphics processing unit (GPU).

The memory 921 is a storage device that temporarily stores data. Specific examples of the memory 921 are static random access memory (SRAM) and dynamic random access memory (DRAM).

The auxiliary storage device 922 is a storage device that stores data. A specific example of the auxiliary storage device 922 is a hard disk drive (HDD). In addition, the auxiliary storage device 922 may be a portable storage medium such as a secure digital (SD, registered trademark) memory card, a compact flash (CF), a NAND flash, a flexible disk, an optical disk, a compact disk, a Blu-Ray (registered trademark) disk, or a digital versatile disk (DVD).

The input interface 930 is a port connected to input devices such as a mouse, a keyboard, and a touch panel. Specifically, the input interface 930 is a universal serial bus (USB) terminal. Note that the input interface 930 may be a port connected to a local area network (LAN). The input interface 930 acquires the program 200 and passes to the instruction execution unit 110.

The output interface 940 is a port to be connected with a cable of a display device such as a display. Specifically, the output interface 940 is a USB terminal or a high-definition multimedia interface (HDMI) (registered trademark) terminal. Specifically, the display is a liquid crystal display (LCD).

The auxiliary storage device 922 stores a program for realizing each function of the instruction execution unit 110, the address rearrangement unit 120, and the evaluation unit 130. The program for realizing each function of the instruction execution unit 110, the address rearrangement unit 120, and the evaluation unit 130 is also referred to as a simulation program 620. This program is loaded into the memory 921, read by the processor 910, and executed by the processor 910. Further, the auxiliary storage device 922 stores an OS. At least a part of the OS stored by the auxiliary storage device 922 is loaded into the memory 921. The processor 910 executes the simulation program 620 while executing the OS.

The simulation device 100 may include only one processor 910, or may include a plurality of processors 910. A plurality of processors 910 may cooperatively execute the program for realizing each function of the instruction execution unit 110, the address rearrangement unit 120, and the evaluation unit 130.

Information, data, signal values, and variable values indicating a result of each processing of the instruction execution unit 110, the address rearrangement unit 120, and the evaluation unit 130 are stored in the auxiliary storage device 922 or the memory 921 of the simulation device 100, or a register or a cache memory in the processor 910.

The program for realizing each function of the instruction execution unit 110, the address rearrangement unit 120, and the evaluation unit 130 may be stored in a portable storage medium. Specifically, the portable recording medium is a magnetic disk, a flexible disk, an optical disk, a compact disk, a Blu-ray (registered trademark) disk, and a digital versatile disk (DVD).

Note that a simulation program product is a storage medium and a storage device in which the simulation program 620 is recorded. The simulation program product refers to what is loaded with a computer readable program regardless of appearance.

### Description of Function

The instruction execution unit 110 converts an instruction code of a processor of a simulation target machine into an instruction code of a processor of a machine that executes simulation, that is, the simulation device 100, and executes the converted instruction code. Here, the simulation target machine is also referred to as a target machine. Further, the processor of the simulation target machine is also referred to as a target CPU. In addition, a machine that executes simulation is also referred to as a host machine. The processor of the machine that executes simulation is also referred to as a host CPU.

That is, the instruction execution unit 110 converts an instruction code of the target CPU of the target machine into an instruction code of the host CPU of the host machine, and executes the converted instruction code. The instruction execution unit 110 is also referred to as an instruction set simulator (ISS) instruction execution unit.

The instruction storage unit 141 stores information of software to be used in the simulation. The instruction storage unit 141 acquires, from the instruction execution unit 110, an instruction address that is an address of an instruction code to be executed next by the instruction execution unit 110, and passes an instruction code recorded in the acquired instruction address to the instruction execution unit 110.

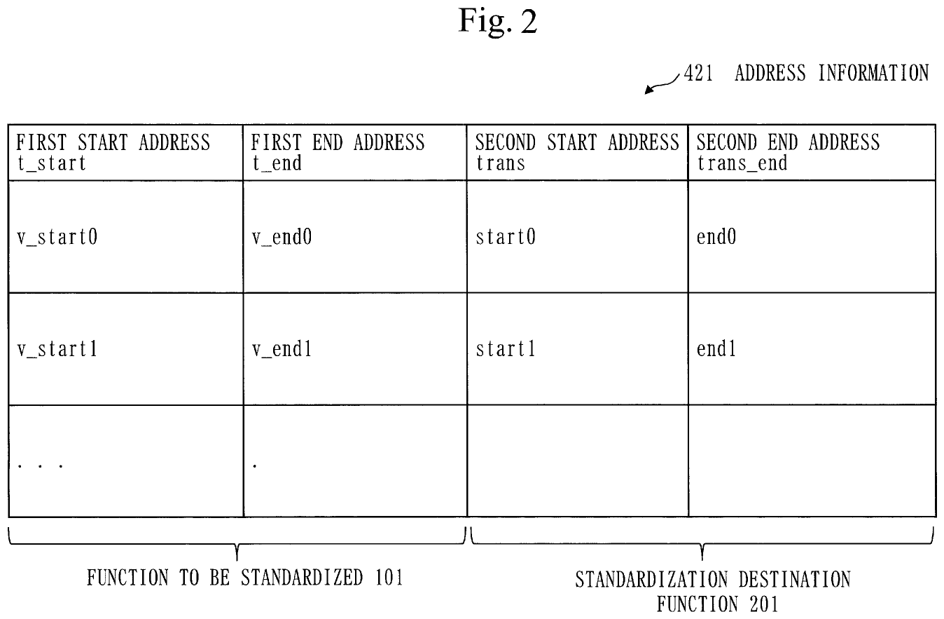

With reference to FIG. 2, a configuration of the address information 421 according to the present embodiment will be described.

The address information storage unit 142 stores the address information 421 in which: a first start address t_start that is a start address of an instruction sequence of the function to be standardized 101; a first end address t_end that is an end address of an instruction sequence of the function to be standardized 101; a second start address trans that is a start address of an instruction sequence of the standardization destination function 201; and a second end address trans_end that is an end address of an instruction sequence of the standardization destination function 201, are associated with each other.

In the address information 421, the second start address trans and the second end address trans_end of the standardization destination function 201 are set corresponding to the first start address t_start and the first end address t_end of the function to be standardized 101. The address information 421 is provided with rows of the number of functions to be standardized 101. The address information 421 is also referred to as an address rearrangement table.

The address rearrangement unit 120 acquires an instruction address from the instruction execution unit 110 as an original address 111, and rearranges the original address 111 to a processing address 121. The address rearrangement unit 120 rearranges the original address 111 to the processing address 121 on the basis of the address information 421, and outputs the processing address 121 to the evaluation unit 130.

The evaluation unit 130 simulates a function of an instruction cache. By being inputted with an instruction address, the evaluation unit 130 determines whether or not an instruction code of the instruction address is stored in the instruction cache. The fact that the instruction code of the inputted instruction address is stored in the instruction cache is called a cache hit, while the fact that the instruction code is not stored in the instruction cache is called a cache miss. The evaluation unit 130 performs cache simulation on the inputted instruction address, to determine whether to be a cache hit or a cache miss. The evaluation unit 130 executes the cache simulation on the processing address 121 outputted from the address rearrangement unit 120, to determine whether to be a cache hit or a cache miss. The evaluation unit 130 is also referred to as an instruction cache model. Here, executing the cache simulation means a process of calculating a corresponding index for the inputted address on the basis of a cache size, a line length, and the number of ways, determining whether there is target data in the cache on the basis of the calculated index, and returning the determination result.

### Description of Operation

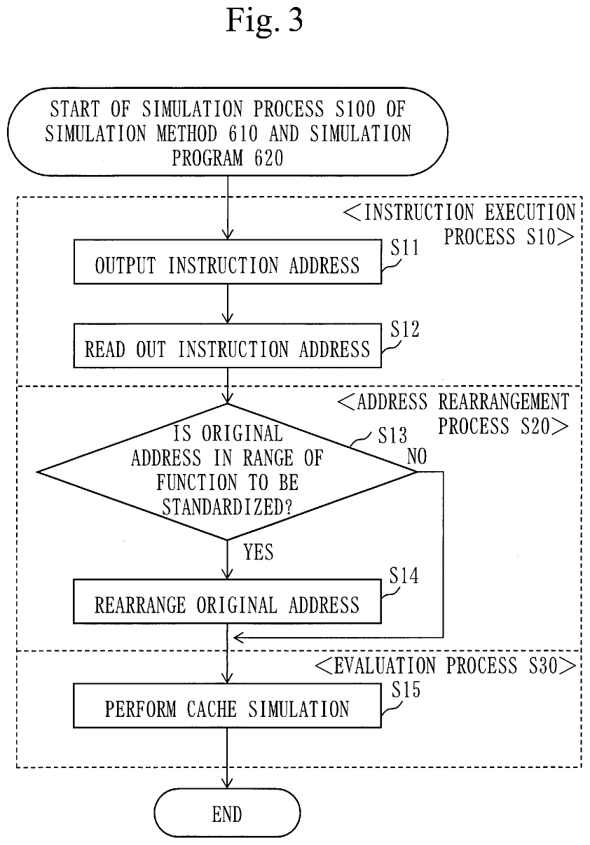

With reference to FIG. 3, the simulation process S100 of the simulation method 610 and the simulation program 620 according to the present embodiment will be described. The simulation process S100 includes an instruction execution process S10, an address rearrangement process S20, and a cache simulation process S30.

### Instruction Execution Process S10

In step S11, the instruction execution unit 110 outputs, as an instruction address 11, an address of an instruction for which the simulation is to be executed next, to the address rearrangement unit 120. Further, the instruction execution unit 110 outputs the instruction address 11 to the instruction storage unit 141 of the storage unit 140.

In step S12, the instruction storage unit 141 acquires an instruction address from the instruction execution unit 110, and passes an instruction code pointed by the instruction address, to the instruction execution unit 110.

### Address Rearrangement Process S20

In step S13, the address rearrangement unit 120 acquires the instruction address 11 as the original address 111 from the instruction execution unit 110. The address rearrangement unit 120 refers to the address information 421 of the storage unit 140, and determines whether or not an instruction code pointed by the original address 111 is included in the function to be standardized 101.

When the instruction code pointed by the original address 111 is included in the function to be standardized 101, the address rearrangement unit 120 proceeds to step S14. When the instruction code pointed by the original address 111 is not included in the function to be standardized 101, the address rearrangement unit 120 proceeds to step S15.

In step S14, the address rearrangement unit 120 rearranges the original address 111 to an address pointing an instruction code of the standardization destination function 201, and outputs as the processing address 121.

### Cache simulation Process S30

In step S15, the evaluation unit 130 performs cache simulation on the processing address 121 outputted from the address rearrangement unit 120, to determine whether to be a cache hit or a cache miss.

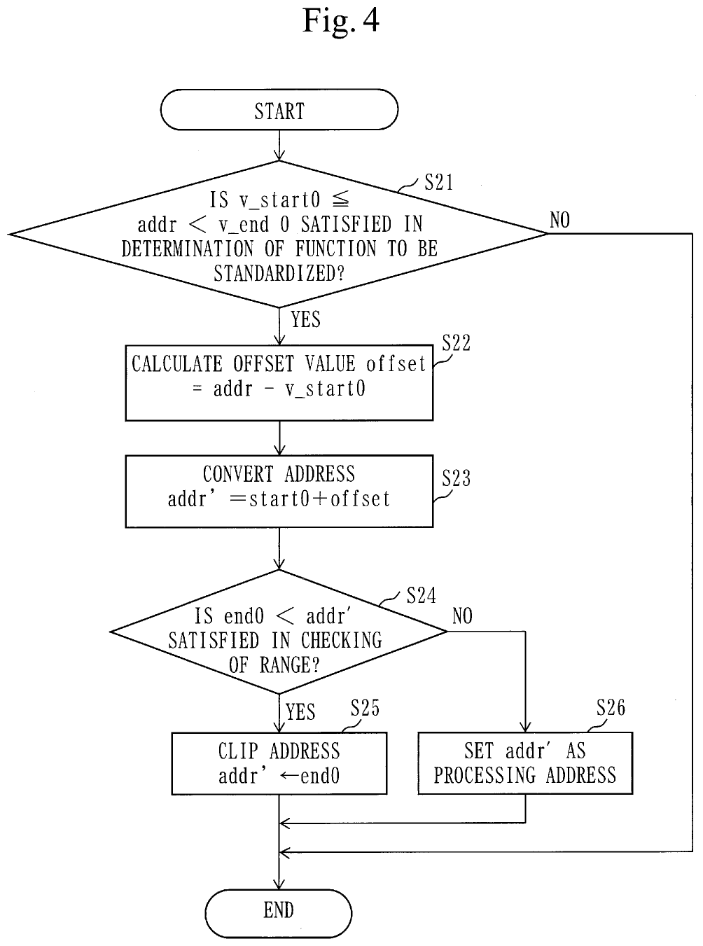

With reference to FIG. 4, the address rearrangement process S20 according to the present embodiment will be described in detail.

In the address rearrangement process S20, the address rearrangement unit 120 acquires, as the original address 111, an address of an instruction sequence for executing the simulation, and determines whether the original address 111 is in between the first start address t_start and the first end address t_end using the address information 421. When the original address 111 is in between the first start address t_start and the first end address t_end, the address rearrangement unit 120 rearranges the original address 111 to between the second start address trans and the second end address trans_end, and sets the rearranged address as the processing address 121.

In step S21, the address rearrangement unit 120 determines whether or not the original address 111 is included in an address range of the function to be standardized 101. Specifically, the address rearrangement unit 120 determines whether or not the original address 111 is an address between from v_start0 that is the first start address t_start of the function to be standardized 101 to v_end0 that is the first end address t_end of the function to be standardized 101 using the address information 421.

When the original address 111 is included in the address range of the function to be standardized 101, the address rearrangement unit 120 proceeds to step S22. When the original address 111 is not included in the address range of the function to be standardized 101, the address rearrangement unit 120 ends the process.

In step S22, when the original address 111 is in between the first start address t_start and the first end address t_end, the address rearrangement unit 120 calculates an offset value offset from the first start address t_start for the original address 111. Specifically, the address rearrangement unit 120 calculates a value from v_start0 to the original address 111 as the offset value offset, with v_start0, which is the first start address t_start, as a reference.

In step S23, the address rearrangement unit 120 calculates an address obtained by adding the offset value offset to the second start address trans, as a rearrangement address addr′. Specifically, the address rearrangement unit 120 adds the offset value offset to start0, which is the second start address trans, to obtain the rearrangement address addr′. The address rearrangement unit 120 rearranges the original address 111 to an address to which the original address 111 is assumed to change when the function is standardized, by adding the offset value offset to the second start address trans of the standardization destination function 201.

In step S24, the address rearrangement unit 120 determines whether the rearrangement address addr′ is included in an address range of the standardization destination function 201. Specifically, the address rearrangement unit 120 determines whether the rearrangement address addr′ is less than end0, which is the second end address trans_end of the standardization destination function 201.

When the rearrangement address addr′ is less than the second end address trans_end, in step S26, the address rearrangement unit 120 outputs the rearrangement address addr′ as the processing address 121, and ends the process.

When the rearrangement address addr′ is equal to or more than the second end address trans_end, in step S25, the address rearrangement unit 120 sets the second end address trans_end as the processing address 121. That is, the address rearrangement unit 120 clips or changes the rearrangement address addr′ to end0, which is the second end address trans_end.

### Other Configuration

In the present embodiment, functions of the instruction execution unit 110, the address rearrangement unit 120, and the evaluation unit 130 are realized by software.

However, as a modification, functions of the instruction execution unit 110, the address rearrangement unit 120, and the evaluation unit 130 may be realized by hardware.

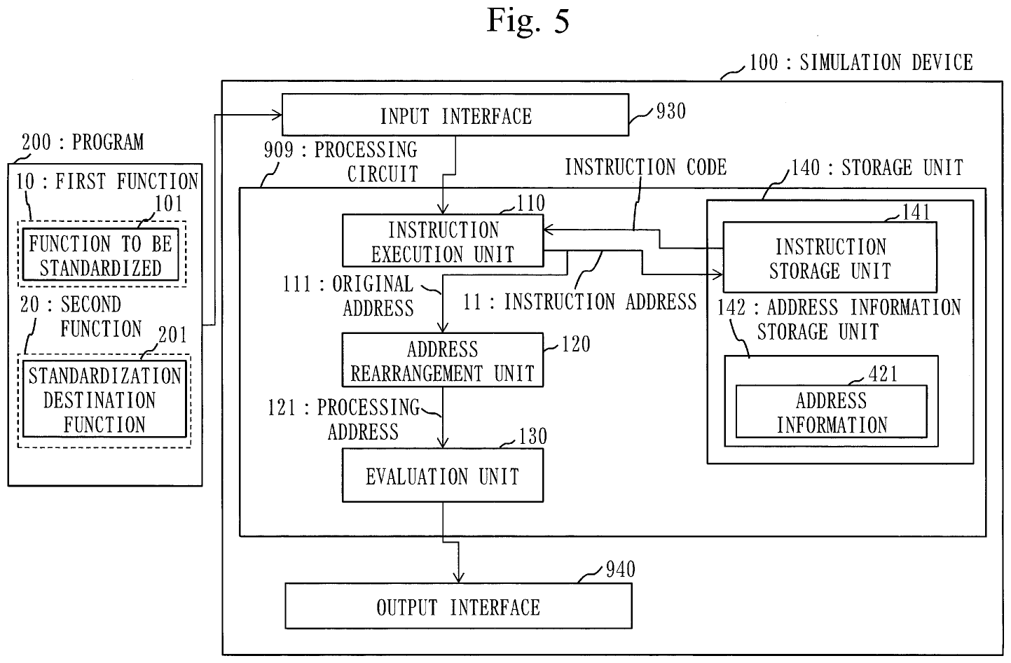

With reference to FIG. 5, a configuration of a simulation device 100 according to a modification of the present embodiment will be described.

As illustrated in FIG. 5, the simulation device 100 includes hardware such as a processing circuit 909, the input interface 930, and the output interface 940.

The processing circuit 909 is a dedicated electronic circuit for realizing functions of the instruction execution unit 110, the address rearrangement unit 120, and the evaluation unit 130, and the storage unit 140 described above. Specifically, the processing circuit 909 is a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

The functions of the instruction execution unit 110, the address rearrangement unit 120, and the evaluation unit 130 may be realized by one processing circuit 909, or may be realized by being distributed to a plurality of processing circuits 909.

As another modification, the functions of the instruction execution unit 110, the address rearrangement unit 120, and the evaluation unit 130 may be realized by a combination of software and hardware. That is, some function of the simulation device 100 may be realized by dedicated hardware, and the remaining function may be realized by software.

The processor 910, the storage device 920, and the processing circuit 909 of the simulation device 100 are collectively referred to as “processing circuitry”. That is, in any of the configurations of the simulation device 100 illustrated in FIG. 1 and FIG. 5, the functions of the instruction execution unit 110, the address rearrangement unit 120, and the evaluation unit 130, and the storage unit 140 are realized by the processing circuitry.

The “unit” may be replaced with “step”, “procedure”, or “processing”. Further, a function of “unit” may be realized by firmware.

### Description of Effect of Present Embodiment

In the simulation device 100 according to the present embodiment, when an inputted original address points the function to be standardized, the address rearrangement unit rearranges the original address to between the start address and the end address of the standardization destination function. Then, the evaluation unit performs cache simulation on the rearranged address, to determine whether to be a cache hit or a cache miss. Therefore, according to the simulation device 100 according to the present embodiment, it is possible to evaluate performance in virtually standardizing overlapping codes before refactoring software. Therefore, according to simulation device 100 according to the present embodiment, it is possible to suppress wasting of man-hours required for refactoring.

In the simulation device 100 according to the present embodiment, on the basis of a processing result of a static analysis tool that detects overlapping codes in software, performance information in a case of standardizing the detected overlapping code is measured. Therefore, according to the simulation device 100 according to the present embodiment, it is possible to more efficiently evaluate performance in virtually standardizing overlapping codes.

In the first embodiment, each part of the simulation device 100 configures the simulation device 100 as an independent functional block. However, without limiting to the above-described embodiment, any configuration of the simulation device 100 may be adopted. Any functional block of the simulation device 100 may be adopted as long as the functions described in the above embodiment can be realized. The simulation device 100 may be configured with any other combination or any block configuration of these functional blocks.

Further, the simulation device 100 may be a system configured by a plurality of devices instead of a single device.

Although the first embodiment has been described, a plurality of parts in this embodiment may be combined and implemented. Alternatively, one part of this embodiment may be implemented. Besides, this embodiment may be implemented entirely or partially in any combination.

It is to be noted that the embodiment described above is a preferable example in nature, and is not intended to limit the scope of the present invention, the scope of the application of the present invention, and the scope of the purpose of the present invention. For the embodiment described above, various modifications are possible as required.

### REFERENCE SIGNS LIST

10: first function, 20: second function, 100: simulation device, 101: function to be standardized, 201: standardization destination function, 110: instruction execution unit, 120: address rearrangement unit, 121: processing address, 130: evaluation unit, 140: storage unit, 141: instruction storage unit, 142: address information storage unit, 421: address information, 11: instruction address, 111: original address, 200: program, 610: simulation method, 620: simulation program, 909: processing circuit, 910: processor, 920: storage device, 921: memory, 922: auxiliary storage device, 930: input interface, 940: output interface, addr′: rearrangement address, offset: offset value, t_start: first start address, t_end: first end address, trans: second start address, trans_end: second end address, S10: instruction execution process, S20: address rearrangement process, S30: evaluation process, S100: simulation process.

1-6. (canceled)

7. A simulation device for executing simulation of a program including a first function and a second function that are similar to each other, the simulation device comprising:
a memory to store address information in which a first start address that is a start address of an instruction sequence of the first function, a first end address that is an end address of an instruction sequence of the first function, a second start address that is a start address of an instruction sequence of the second function, and a second end address that is an end address of an instruction sequence of the second function, are associated with each other; and
processing circuitry
to acquire, as an original address, an address of an instruction sequence for executing simulation, to determine whether the original address is in between the first start address and the first end address using the address information, to rearrange the original address to between the second start address and the second end address when the original address is in between the first start address and the first end address, and to set a rearranged address as a processing address, and
to execute cache simulation on the processing address, and to evaluate whether to be a cache hit or a cache miss.

8. The simulation device according to claim 7, wherein
the processing circuitry
outputs, as an instruction address, an address of an instruction for executing simulation next, and
acquires the instruction address as the original address.

9. The simulation device according to claim 7, wherein
the processing circuitry
calculates an offset value from the first start address for the original address when the original address is in between the first start address and the first end address, calculates an address obtained by adding the offset value to the second start address as a rearrangement address, and sets the rearrangement address as the processing address when the rearrangement address is less than the second end address.

10. The simulation device according to claim 8, wherein
the processing circuitry
calculates an offset value from the first start address for the original address when the original address is in between the first start address and the first end address, calculates an address obtained by adding the offset value to the second start address as a rearrangement address, and sets the rearrangement address as the processing address when the rearrangement address is less than the second end address.

11. The simulation device according to claim 9, wherein
the processing circuitry
sets the second end address as the processing address when the rearrangement address is equal to or more than the second end address.

12. The simulation device according to claim 10, wherein
the processing circuitry
sets the second end address as the processing address when the rearrangement address is equal to or more than the second end address.

13. A simulation method of a simulation device for executing simulation of a first function and a second function that are similar to each other, wherein
the simulation device comprises a memory to store address information in which a first start address that is a start address of an instruction sequence of the first function, a first end address that is an end address of an instruction sequence of the first function, a second start address that is a start address of an instruction sequence of the second function, and a second end address that is an end address of an instruction sequence of the second function, are associated with each other,
the simulation method comprising:
acquiring, as an original address, an address of an instruction sequence for executing simulation, determining whether the original address is in between the first start address and the first end address using the address information, rearranging the original address to between the second start address and the second end address when the original address is in between the first start address and the first end address, and setting a rearranged address as a processing address, and
executing cache simulation on the processing address, and evaluating whether to be a cache hit or a cache miss.

14. A non-transitory computer readable medium storing a simulation program of a simulation device for executing simulation of a program including a first function and a second function that are similar to each other, wherein
the simulation device comprises a memory to store address information in which a first start address that is a start address of an instruction sequence of the first function, a first end address that is an end address of an instruction sequence of the first function, a second start address that is a start address of an instruction sequence of the second function, and a second end address that is an end address of an instruction sequence of the second function, are associated with each other,
the simulation program causing the simulation device that is a computer to execute:
an address rearrangement process to acquire, as an original address, an address of an instruction sequence for executing simulation, to determine whether the original address is in between the first start address and the first end address using the address information, to rearrange the original address to between the second start address and the second end address when the original address is in between the first start address and the first end address, and to set a rearranged address as a processing address; and
an evaluation process to execute cache simulation on the processing address, and to evaluate whether to be a cache hit or a cache miss.
